(19) United States
(12) Patent Application Publication
(10) Pub. No.: US 2021/0073868 A1
(43) Pub. Date: Mar. 11, 2021

(54) SYSTEM AND METHOD FOR ADVERTISING SALES

(71) Applicant: Good Life Networks Inc., Vancouver (CA)

(72) Inventor: Christopher BRADLEY, Durham (GB)

(21) Appl. No.: 16/963,127

(22) PCT Filed: Jan. 18, 2019
(86) PCT No.: PCT/CA2019/050068

§ 371 Date: Sep. 17, 2020

Related U.S. Application Data
(60) Provisional application No. 62/619,450, filed on Jan. 19, 2018.

(51) Int. Cl. G06Q 30/02; G06Q 30/06

(52) U.S. Cl. CPC G06Q 30/0273; G06Q 30/0269; G06Q 30/0611; G06Q 30/0609; G06Q 30/0247

(57) ABSTRACT

Systems and methods for online advertising. A trading platform system for advertising has a trading data processor and an analysis data processor along with a first database for buyer profiles and a second database for generic target user profiles. Based on the buyer profiles and the target user profile, specific buyers are placed on a list of potential buyers for a specific advertising opportunity. An offer for the opportunity is then sequentially made to each of the potential buyers until one of the potential buyers accepts the offer. The buyer who accepts the offer is allowed to show their advertising content. If an accepting buyer does not complete the transaction, the offer is sent to the next potential buyer on the list. On completion of the transaction, the various databases and the buyer profiles are adjusted with the sales data.

### TECHNICAL FIELD

The present invention relates to online advertising. More specifically, the present invention relates to systems and methods for buying and selling online video advertising.

### BACKGROUND OF THE INVENTION

The information revolution of the 2000s and 2010s has led to an explosion in access to the Internet. Internet access is now widely available throughout the world and is now a necessity for millions. It has also led to an explosion in online advertising.

Online advertising used to simply be banners and static advertising on websites. Nowadays, because of greater access to high speed data links, most websites offer video advertising with website visitors being inundated (in some cases) by multiple advertising video feeds.

The presence, placement, and duration of such video advertising on websites is bought and sold by millions of advertisers and this trade is worth millions of dollars. However, current trading techniques are inefficient, leading to a poor fit between advertising space and the users targeted by advertisers. As well, website owners are not maximizing their opportunities because advertising space on their website is not being sold to advertisers willing to pay for the uniqueness of the user accessing the website. As an example, a female user in her twenties living in the southwest region of the United States would not be a suitable target for an advertising video selling snow tires for large 4×4 trucks. However, because advertising space for such tires was bought in bulk by the tire manufacturer for a low price, the unwitting user now has to endure the advertising video. An opportunity for the website owner has been lost as another advertiser for women's athletic wear, unbeknown to the website owner, was willing to pay a much higher price for the same advertising space on the same user's device.

Another potential issue arises when advertising space is put up for auction and is won by a non-performing advertiser. In this circumstance, the advertising space was bid on and won by a specific advertiser but that advertiser's video for that specific advertising space was, for a multitude of possible reasons, unable to be shown to the user on the website. This leads to the website owner (or the advertising seller) having to, again, put up the advertising space for auction. While this might not be much of an issue as such auctions happen automatically hundreds if not thousands of times a second between the advertiser servers and the advertising seller servers, it does represent a lost opportunity for the advertiser seller to monetize the user's precious time on the website.

As would be known to a person skilled in the field of online advertising and as noted above, online advertising moves very swiftly as advertiser servers are offered advertising space on multiple websites by advertiser seller servers or by trading platforms that seek to facilitate such transactions. However, while such trading platforms are useful as they allow for real-time bidding on auctions for such advertising space, they do not allow for the volumes of advertising space available nowadays. Current systems struggle to deal with the available data about users along with the requirements or desires of advertiser sellers (or publishers) about their available advertising space. Added to this mix is the advertiser buyer who seeks to maximize the impact of their advertising on the user.

For a better understanding of the issues with current systems, the process involving advertising space should be clear. A user lands on a webpage and this causes the web page's publisher (i.e. the server for the publisher) to notify a trading platform. The platform then offers one or more advertising space slots on the webpage for that specific user to advertising buyers. These buyers then examine their targeting data and the data about the specific user and, based on these data sets, the various buyers can enter a bid for the advertising space slots on the webpage. The buyer with the winning bid is then given the opportunity to show their advertising (e.g. an advertising video) to the user on the webpage.

From the above, there is therefore a need for systems and methods that allow for advertiser sellers (or publishers) to increase their revenue while managing the data associated with the users, the advertising buyer, and the advertising marketplace as a whole.

### SUMMARY OF INVENTION

The present invention provides systems and methods for online advertising. A trading platform system for advertising has a trading data processor and an analysis data processor along with a first database for buyer profiles and a second database for target user profiles. Buyer profiles in the database include various metrics such as transaction completion rates, previous buys by the buyer, the amount paid, types of advertisements, and other buyer preferences. Based on the buyer profiles and the target user profile, specific buyers are targeted for a sales offer for the specific target user advertising opportunity. Buyers who take up or accept the offer are allowed to show their advertising content and if an accepting buyer does not complete the transaction, advertising opportunity is offered to another buyer to show their content. Once the transaction has been completed, the sales data is used to update the various databases and to adjust the buyer profiles.

In a first aspect, the present invention provides a system for facilitating a buying and selling of advertising spaces, the system comprising:
a first data storage medium for storing buyer profiles for advertiser buyers;
a second data storage medium for storing target user profiles for potential advertising viewers;
a first data processor for analyzing previous sales of advertising spaces and for adjusting said buyer profiles;
a second data processor for receiving notification of an available advertising space from an advertising seller and for determining which advertising buyers are to be added to a potential buyer list for said available advertising space;

wherein
said advertising spaces are for online videos;
when an advertising sale has been completed, sales results are used to adjust said buyer profiles;
advertising buyers in said potential buyer list are sequentially offered said available advertising space for a specific price;
said second data processor determines which advertising buyers are in said potential buyer list based at least on said buyer profiles and based on a specific target user profile for a target user viewing a website that contains said available advertising space;
an offer of said available advertising space is provided, in turn, to each buyer in said potential buyer list until a potential buyer accepts said offer at said specific price.

In another aspect, the present invention provides a method for conducting a sale for advertising space, the method comprising:
a) analyzing previous sales and attempted sales to derive buyer data for a plurality of buyers, said buyer data being based on results of said previous sales;
b) receiving an advertising opportunity from a specific seller for a webpage being viewed by a specific target user;
c) determining parameters for said advertising opportunity based on a target user profile for said specific target user;
d) assessing said buyers based on said parameters and said buyer data to result in assessment results for each one of said buyers;
e) based at least one on said assessment results, compiling a list of potential buyers, said list of potential buyers being a subset of said plurality of buyers;
f) sending an offer for a specific price for said advertising opportunity to a specific potential buyer in said list;
g) receiving sales results from said specific potential buyer in said list;
h) if said sales result is positive, allowing said potential buyer to use specific advertising with said advertising opportunity;
i) if said sales result is negative, repeating steps f)-i) for each of said potential buyers in said list until a positive sales result is received or until said list is exhausted of potential buyers.

In yet another aspect, the present invention provides a method for selling advertising spaces, the method comprising:

a) analyzing buyer profiles to determine suitable potential buyers based on metrics and data stored in said buyer profiles;
b) analyzing a target user profile for a target user viewing a website having available advertising space;
c) analyzing said buyer profiles based on said available advertising space and based on data in said target user profile;
d) determining a sale price for said available advertising space on said website based on said target user profile and said potential buyers;
e) compiling a list of said potential buyers based on analyses in steps a) and b);
f) offering said available advertising space at a specific price to each potential buyer in said list, an offer being made to each potential buyer in turn;
g) continuously executing step f) until said list is exhausted or until one of said potential buyers has accepted said offer.

In a further aspect, the present invention provides computer readable media having encoded thereon computer readable and computer executable code that, when executed, implements a method for conducting a sale for advertising space, the method comprising:

a) analyzing previous sales and attempted sales to derive buyer data for a plurality of buyers, said buyer data being based on results of said previous sales;
b) receiving an advertising opportunity from a specific seller for a webpage being viewed by a specific target user;
c) determining parameters for said advertising opportunity based on a target user profile for said specific target user;
d) assessing said buyers based on said parameters and said buyer data to result in assessment results for each one of said buyers;
e) based at least one on said assessment results, compiling a list of potential buyers, said list of potential buyers being a subset of said plurality of buyers;
f) sending an offer for a specific price for said advertising opportunity to a specific potential buyer in said list;
g) receiving sales results from said specific potential buyer in said list;
h) if said sales result is positive, allowing said potential buyer to use specific advertising with said advertising opportunity;
i) if said sales result is negative, repeating steps f)-i) for each of said potential buyers in said list until a positive sales result is received or until said list is exhausted of potential buyers.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention; and

FIG. 2 is a flowchart detailing a method according to another aspect of the present invention.

### DETAILED DESCRIPTION

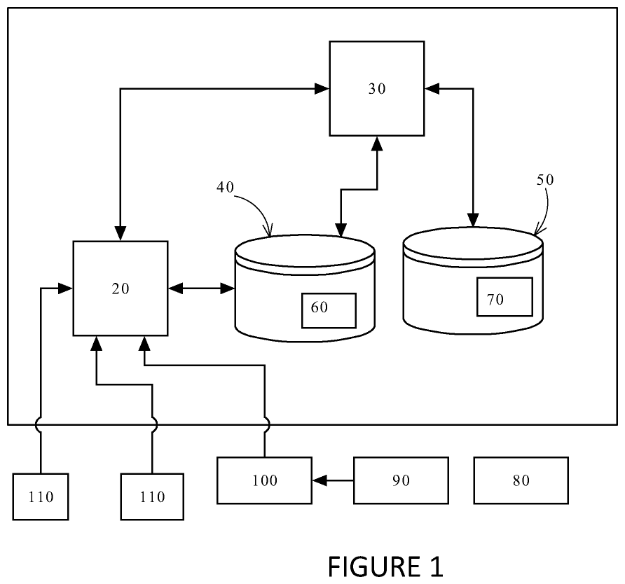

Referring to FIG. 1, a block diagram of a system according to one aspect of the invention is illustrated. The system 10 includes a trading subsystem 20, an analysis subsystem 30, a first database 40, and a second database 50. Within the first database 40 are buyer profiles 60 while second database 50 contains target user profiles 70. In operation, when a target user 80 lands on a webpage 90, a message is sent from a seller server 100 to the trading subsystem 20. Data about the target user 80 is sent with the message and the trading subsystem 20 determines, based on the target user's profile from second database 50 and based on buyer profiles from the first database 40, which buyers are to be included in a list of potential buyers for advertising space on the webpage 90. The first of these potential buyers in the list is sent an offer from trading subsystem 20 including the data about the target user 80 and a sale price. Acceptance or rejection of this offer is then sent from the buyer 110 to the trading subsystem 20. If the potential buyer 110 has accepted the offer, then that accepting buyer is allowed to display its advertising on the webpage 90. On the other hand, if that first potential buyer rejects the offer, the next potential buyer in the list is then sent the offer for the same price. This process continues for each of the potential buyers in the list until one of the buyers has accepted the offer. Once a sale has been completed (i.e., the offer has been accepted and the accepting buyer has displayed its advertisement on the webpage), the details regarding that sale and transaction are then sent to the analysis subsystem 30 to update the buyer profiles 60 and target user profiles 70 (if necessary) on the first database 40 and second database 50.

It should be clear that the trading subsystem 20 may include a trading server 120 connected to the databases 40,50 by way of a suitable network connection. Similarly, analysis subsystem 30 may include an analysis server 130 connected to the databases 40, 50 by a similarly suitable network connection. These servers may take the form of discrete computer servers or they may be virtualized machines operating on one or more physical servers.

Regarding the buyer profiles in the first database 40, these profiles contain details regarding the advertiser buyer including performance metrics for the buyer from previous auctions. Such information may include: geographical regions that the buyer is interested in, keywords regarding the buyer's advertisements and what is being promoted/being sold in the advertisements (e.g., transportation, cars, trucks, consumer products, hygiene products, adult movies, TV shows, political, etc., etc.) as well as the types of content of advertisements that the buyer buys for (e.g. banner ads, full motion video). The buyer's performance metrics are also contained in the profile and these metrics may include: sale rate (how many offers were accepted), incomplete transaction rate (how many i accepted offers were incomplete transactions (i.e. the buyer accepted the offer but, for some reason, the content was not shown to the user)), completed transaction rate (what percentage of accepted offers were completed as a transaction by the buyer with the user viewing the advertising content), prices for the accepted offers, loss rate (how many offers made to the buyer were rejected), losing offers (an average price for offers made to but rejected by the buyer), winning offer rate (an average price for offers made to and accepted by the buyer).

Similar to the buyer profiles, the target user profiles in the second database 50 contain details regarding the target user viewing the advertiser seller's website. The target user profiles may include details about the target user and the seller whose website is being viewed. As such, the target user profiles may include the user's location, the location of the seller's market (e.g. the seller may be a car dealership with outlets in the US southwest states), the seller's preferences in terms of buyers (e.g. the seller may not want to sell to buyers advertising political campaigns), buyer restrictions (e.g. if the seller is a webpage primarily aimed at children, the buyer cannot be an advertiser for cigarettes or other tobacco products or the seller may not want adult advertising on its webpage or the seller may not want advertising relating to online dating), seller price characteristics (e.g. a seller may have a minimum price for any of its advertising spaces or a minimum price for specific types of advertising), seller website type and/or category, and seller preferences (if any) in terms of desired end result (e.g. the seller may simply want to sell all advertising spaces regardless of buyer or price or the seller may want to maximize the price paid for the advertising space or the seller may want to minimize the number of incomplete transactions). Other information regarding the target user may also be present in the target user profiles including information about the user's device, the user's locale, and the user's interests (based on the seller website).

It should be clear that the trading subsystem determines which buyers are to be included in the list of potential buyers for an advertising opportunity based on data in the target user profile as well as on data in the buyer profiles. As a first instance, the buyers eligible to be placed on the list for the advertising opportunity may be filtered based on the seller's preferences as listed in the target user's profile. As an example, if a news organization's webpage has an available advertising space and the target user's profile indicates that the seller does not want adult or online dating related advertising, the buyers who are advertising adult services or adult websites are excluded from being eligible to be placed on the potential buyer list. As well, buyers advertising online dating websites, or anything related to online dating may similarly be filtered out as being ineligible to bid on the advertising opportunity.

Once the clearly ineligible buyers have been filtered out, the unlikely buyers may also be filtered out. As an example, if the seller is a website for a pet store located in New York City, a buyer advertising a landscaping services company only offering such services in Los Angeles may be an unlikely buyer. Similarly, buyers for competitors of the seller may also be filtered out. As another example, a buyer buying advertising space for an express shipping company is unlikely to buy advertising space on a webpage for a freight company having the same or similar services.

The remaining buyers may then be assessed to determine if the buyer preferences match with the parameters of the target user. This assessment may be done by determining how aligned or how much of a match there is between the buyer preferences and the target user's profile. This assessment may take into account the buyer's completion/acceptance rate, incomplete transaction rate, prices for accepted offers, loss rate, losing offer rate, and accepted offer rate. In addition to an assessment based on these performance metrics, each buyer may further be assessed based on other data points such as the buyer's market's proximity to the user (e.g. if the buyer is a car dealership in Los Angeles, then the buyer would be given a better match for locale if the user is located in the southwestern US than if the buyer was a car dealership in New Jersey).

Based on the assessments for each of the remaining buyers, a subset of buyers is selected to form an list of potential buyers. Each of the buyers in the list is sequentially sent an offer on the advertising space on the seller's webpage. As part of the offer, any data sent by the seller to the trading subsystem about the target user is also included in the offer along with a price. That way, the potential buyers can assess the advertising opportunity. This target user data may include whatever demographic data is available about the user, including location (general location such as city, area of the country, country, etc.), children, etc., etc. Personally identifiable information (PII) is not included in the user data from the seller sent to the trading subsystem. Data such as the user's locale, device information, and interests may also be included. Based on the offer and the user data, the buyers who have been sent the offer can send in an acceptance or a rejection to the trading subsystem.

Once a potential buyer has accepted the offer at the offered price, the accepting buyer is then allowed access to the advertising space on the seller's webpage so that the target user may view the advertising content. Of course, depending on circumstances, the accepting buyer may not complete the transaction so that the advertising content is not presented to the user. If this occurs, the trading subsystem then selects the next potential buyer in the list of potential buyers and the offer is sent to this next potential buyer. This step of successively offering the advertising space to the potential buyers in the list will continue until a potential buyer accepts the offer and is able to present its advertising content to the user.

Once the transaction has been completed, the sale's results, as well as the circumstances surrounding the sale (e.g. any incomplete transactions and any rejections of the offer) are then sent to the analysis subsystem. The analysis subsystem then analyzes these data points and updates the various buyer and target user profiles as necessary in the databases.

In another embodiment, a third database may be present. The third database may contain data for the sellers. Such data may be mined should other considerations be taken into account when formulating or editing the various buyer or target user profiles. As an example, should the number of completed buyer transactions now be a consideration, the historical data for previous sales can be mined for the number of completed transactions for the various buyers. Similarly, consideration may be given as to whether a specific buyer/seller pairing results in an offer acceptance or a successful transaction. The historical data for previous sales can similarly be mined for data regarding different buyer/seller pairings.

Given that there may be thousands upon thousands of such advertising transactions per minute if not per second, it would be an onerous task to update the buyer and user and/or seller profiles in real-time based on the results of these transactions and auctions. Accordingly, while the analysis subsystem continuously receives sales results (including all acceptances and rejections) and transaction results, the analysis subsystem may only update the buyer and user profiles once every few minutes. In one implementation, updates of these profiles only occur once every five minutes. Thus, automated decisions regarding which buyers to include in the potential buyer list are made based on data that is, at most, a few minutes old.

It should also be noted that how the matching or assessment for each buyer/user is accomplished may be dependent on the seller's and/or buyer's preferences. As an example, if a seller's preference is for as small a number of incomplete transactions as possible, then the scoring for the buyers may be adjusted so that greater weight is given to each buyer's incomplete transaction rate. Conversely, if the seller's preference is for as high a price as possible for the advertising space, each buyer's average accepted price may be weighted heavier so as to have a greater effect on the resulting score for each buyer. To this end, scoring each buyer prior to a sale (with the score being used to select buyers to include in the potential buyers list) may be done. However, if there are a large number of potential buyers and if there are a lot of data points to take into consideration when formulating the score for each buyer, each buyer may have a number of different scores within its profile. Each buyer profile may thus have a first score weighted so that an average sale price is highlighted. A second score may have the buyer's incomplete transaction rate highlighted with a heavier weighting. Or, conversely, the buyer's completed transaction rate may be weighted higher so that this rate is highlighted in the buyer's score. Rather than having to be calculated every time a sale is to be run, these scores may be pre-calculated and stored in each buyer's profile. Thus, the trading subsystem, prior to running a sale, simply has to access a seller's profile or a target user's profile to find the seller's preferences. Based on these preferences, the trading subsystem can access each buyer's profile to check the relevant score in each buyer's profile to determine if the buyer is suitable for inclusion in the list of potential buyers. Instead of retrieving multiple data points per buyer profile, the trading subsystem simply has to retrieve a single pre-calculated score for each buyer to determine if the buyer is to be included in the list of potential buyers. As noted above, each buyer profile would thus have different pre-calculated scores with each pre-calculated score being appropriately weighted to highlight one or more of that buyer's performance metrics.

In another implementation, given the large volumes of advertising spaces being traded, sold, and completed, it would be impossible to code for all possibilities. As such the trading subsystem includes artificial intelligence to determine probabilities of sales success based on previous sales and based on current trading patterns. In this implementation, the analysis subsystem would analyze current trading patterns and, based on those trading patterns, weight each buyer (and possibly each buyer's performance metrics) accordingly. The aim is to thus predict, with as much accuracy as possible, which buyers are most likely to accept a specific offer. This analysis may take into account the data in the buyer's profile, the seller's preferences, the target user's data, and whether the buyer has recently been active or not (with recentness being measured in hours if not minutes). The likelihood of each buyer accepting a given offer may be that buyer's score for that advertisement opportunity. A higher score for a sale means a greater probability that the buyer will not just accept a specific offer but also complete the transaction. Those buyers with the highest scores for a given potential sale are placed in the highest tier of the list of potential buyers and are sequentially offered the advertising opportunity until one of those potential buyers accepts the offer.

Once a sale has been completed, the data for that sale can then be used to update the buyer profiles and to update the predictions for the trading patterns. Thus, if, as noted above, updates to the data are only accomplished every five minutes, then the trading pattern used to assess buyers is, at most, five minutes old. It should, of course, be clear that, for every buyer, every accepted offer and every rejected offer is noted and recorded in that buyer's profile.

It should be clear that the artificial intelligence used in the system continuously adjusts the weightings and the decision paths necessary to arrive at the predicted outcome for the auction pool. Thus, if the system predicts that buyer A will accept a given offer and buyer A does NOT accept that offer, this result will be reflected by changed weightings on buyer A's profile as well as in possible changes to the trading pattern used to predict that buyer A will accept the offer.

As can be imagined, the artificial intelligence in the system can be trained to continuously adjust whatever variables are necessary to arrive at the desired end result. For this implementation, the desired end result is a successful prediction as to which buyer will accept a given offer for an advertising opportunity for a specific webpage for a specific seller and to be viewed by a specific target user. The starting point would be the user's data and the process would take into account each buyer's performance metrics, the seller's preferences, the data in the seller's profile, as well as other data in the buyer's profile and data in the target user's profile. And, of course, any prevailing data patterns would also be taken into account (e.g. whether a buyer has been aggressively buying advertising space, whether the seller has been asking for a higher price for its advertising spaces, etc., etc.).

It should also be clear that the system may continuously calculate the relevant probabilities for each buyer given a specific seller and/or a specific target user and given any current trading patterns.

As noted above, an assessment is performed to determine if a buyer's requirements are a match to the characteristics of a specific target user in an advertising opportunity on a webpage/website. The amount of a match between the buyer's requirements (as noted in the buyer's profile) and the data in the specific target user's profile may be used to determine the price to be used to offer the advertising opportunity. If there is a definite match between the two datasets, then this may be priced at one price level. However, if there is only a partial match between the requirements in the buyer's profile and the data in the target user's profile, this may cause the offer to be priced at a different (and possibly lower) price level. It should be clear that, for a no match (a situation where the buyer's requirements are not matched at all to the target user profile data), a default price level may be used. As can be imagined, this default price level is much lower than the price levels used for a direct match or a partial match.

To assist in managing the accesses to the various databases in the system, data to be written to or to be retrieved from the databases may be grouped. The system continuously receives data regarding events that affect an advertising opportunity, and which may be used to predict better matches. As an example, even after an advertising opportunity has been sold, the system still receives updates as to the events on the webpage for that opportunity. Thus, events such as the loading of the buyer's video, starting the video, video viewed 25%, video interacted with, etc., etc. are reported back to the system. All of these events are reported back and queued for processing and storage into the relevant buyer profile and/or the relevant target user profile. Queued events are processed in batches or in groups and, since events affecting a specific user/buyer combination would occur in relative quick succession, these events may be grouped together within a specific batch. Thus, if 100 events are in a specific batch and, of those 100 events, 20 events relate to a specific webpage/buyer-user combination, then these 20 events can be grouped together or merged within the batch, so they can be processed as a single event and not as 20 individual events. By doing so, instead of querying the databases for 20 individual events, a single query for that specific webpage/buyer-user combination is performed, thereby reducing the amount of accesses to the database.

From the above, by tracking the progress of an advertisement on a webpage and how the target user reacts to that advertisement, the system can use that data for better matches between target users and buyers. Thus, data that a specific target user or a specific type of target user is known for viewing advertisement videos until the end can be used to determine a better price for future advertising opportunities involving that specific target user type. Similarly, another target user type who is known for shutting down all advertising videos even before the videos have loaded may require that future advertising opportunities involving this user type may be priced at a lower price level.

It should also be clear that the artificial intelligence noted above may be used for more than simply determining the correct price and predicting which buyer will accept specific offers. The system may also use artificial intelligence to analyze the data in the databases to predict target user behaviour based on similar user profiles and, accordingly, make better offers to those buyers who are more likely to accept those offers. Thus, by grouping users into user types based on behaviour (and interests as shown by the webpage type/category), an incoming advertising opportunity can be routed to specific buyers whose profile matches the target user's characteristics. Thus, better target user-buyer matches can be found and, in the end, advertisements which are more relevant to a target user's interests can be delivered to the user for a better price for the buyer. Grouping users not simply by behaviour but also by surrounding circumstances may also lead to better matches. As an example, the data may show that advertisements directed at Android users in Chicago on Tuesdays on sports related webpages are more likely to be viewed to completion. This may thus lead the system to cause similar advertising opportunities to be priced not simply higher but also to be directed to a specific group or type of buyer.

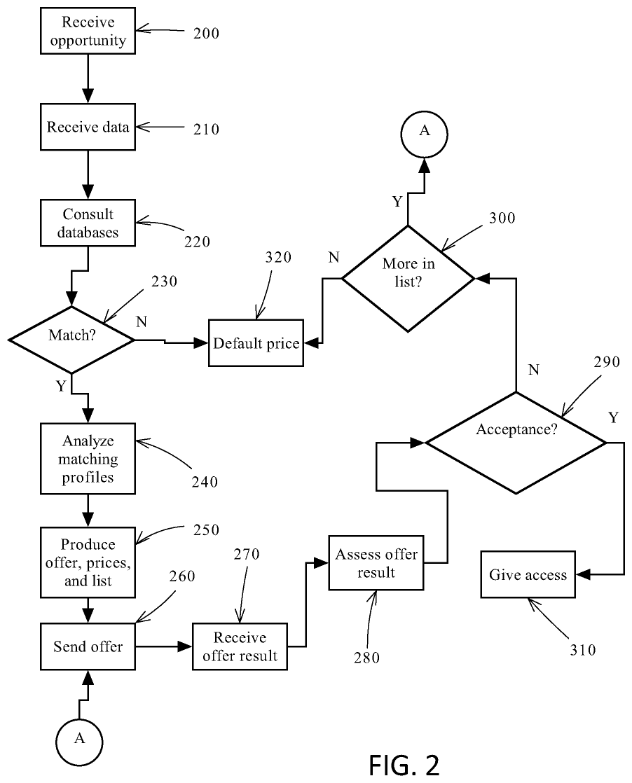

The system noted in FIG. 1 and described above may implement a method as shown in FIG. 2. In FIG. 2, the steps in such a method are illustrated as being initiated at step 200, that of receiving an incoming advertising opportunity for a webpage being viewed by a specific target user. In step 210, data regarding the advertising opportunity is received, including non-PII data regarding the target user (e.g. location, device type, device ID, type of webpage being viewed, category of webpage content, etc.). In step 220, the databases are consulted to determine if there is a match between the data received for the target user and target user profiles. As can be imagined, these target user profiles are not specific to an individual but are profiles based on non-PII data such as location, interests, device type, etc. If there is a match to a specific target user profile, then in step 230, the database is consulted to see if there is a match to one or more buyer profiles, especially with regard to buyer requirements regarding the advertising opportunity. In step 240, any matching buyer profiles, the matching user profiles, and any other data regarding the advertising opportunity are then analyzed together to result (step 250) at a suitable offer, one or more suitable prices for the offer, and a list of potential buyers for the opportunity. The offer and a suitable price for the advertising opportunity are then sent to one of the potential buyers in the list (step 260). An offer result is then received (step 270) and this result is assessed (step 280). If the result is an acceptance (step 290), then the buyer's advertisement is allowed access to the webpage (step 310). If the result is a rejection, then a check is made to see if there are other buyers on the list (step 300) and, if there are, then the process loops to step 260 as the next buyer in the list is contacted with the offer and a suitable price (which may be different from the first price). Steps 260-300 are looped until an acceptance is received or until the check is step 300 results in no more potential buyers in the list. If there are no more buyers in the list, then a default price may be assigned to the opportunity and may be offered to other non-matching buyers (step 320). Regarding step 230, if there are no matching profiles, the opportunity is assigned a default price and offered to other buyers per step 320.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for facilitating a buying and selling of advertising spaces, the system comprising:
a first data storage medium for storing buyer profiles for advertiser buyers;
a second data storage medium for storing target user profiles for potential advertising viewers;
a first data processor for analyzing previous sales of advertising spaces and for adjusting said buyer profiles;
a second data processor for receiving notification of an available advertising space from an advertising seller and for determining which advertising buyers are to be added to a potential buyer list for said available advertising space;
wherein
said advertising spaces are for online videos;
when an advertising sale has been completed, sales results are used to adjust said buyer profiles;
advertising buyers in said potential buyer list are sequentially offered said available advertising space for a specific price;
said second data processor determines which advertising buyers are in said potential buyer list based at least on said buyer profiles and based on a specific target user profile for a target user viewing a website that contains said available advertising space;
an offer of said available advertising space is provided, in turn, to each buyer in said potential buyer list until a potential buyer accepts said offer at said specific price.

2. A system according to claim 1, wherein said first data processor is for analyzing current sales to determine advertising buying patterns, said advertising buying patterns being used to adjust buyer profiles.

3. A system according to claim 2, wherein said advertising buying patterns are used to determine which buyers are to be added to said potential buyer list.

4. A system according to claim 2, wherein said system further comprises an artificially intelligent component for determining said advertising buying patterns.

5. A system according to claim 1, wherein said notifications of available advertising spaces include demographic data regarding said target user.

6. A system according to claim 5, wherein said demographic data is sent to said advertising buyers included in said potential buyer list.

7. A system according to claim 1, wherein said advertising buyers to be included in said potential buyer list are selected based at least partially on performance metrics for said advertising buyers.

8. A system according to claim 7, wherein said performance metrics for said advertising buyers are stored in said buyer profiles for said advertising buyers.

9. A system according to claim 1, wherein said target user profiles include data relating to seller preferences for advertising content to be presented on said available advertising spaces.

10. A method for conducting a sale for advertising space, the method comprising:
a) analyzing previous sales and attempted sales to derive buyer data for a plurality of buyers, said buyer data being based on results of said previous sales;
b) receiving an advertising opportunity from a specific seller for a webpage being viewed by a specific target user;
c) determining parameters for said advertising opportunity based on a target user profile for said specific target user;
d) assessing said buyers based on said parameters and said buyer data to result in assessment results for each one of said buyers;
e) based at least one on said assessment results, compiling a list of potential buyers, said list of potential buyers being a subset of said plurality of buyers;
f) sending an offer for a specific price for said advertising opportunity to a specific potential buyer in said list;
g) receiving sales results from said specific potential buyer in said list;
h) if said sales result is positive, allowing said potential buyer to use specific advertising with said advertising opportunity;
i) if said sales result is negative, repeating steps f)-i) for each of said potential buyers in said list until a positive sales result is received or until said list is exhausted of potential buyers.

11. A method according to claim 10, wherein in the event a buyer accepting said offer is unable to advertise on said webpage, said method includes a step of sending said offer to another potential buyer on said list and allowing said another potential buyer access to said advertising opportunity if said another potential buyer has accepted said offer.

12. A method according to claim 10, wherein said method comprises a step of analyzing previous sales to determine advertising data patterns.

13. A method according to claim 12, wherein said advertising data patterns are used in determining which buyers to include in said list of potential buyers.

14. A method according to claim 10, wherein said advertising opportunity is an opportunity to present a video advertising piece on said webpage.

15. A method for selling advertising spaces, the method comprising:
a) analyzing buyer profiles to determine suitable potential buyers based on metrics and data stored in said buyer profiles;
b) analyzing a target user profile for a target user viewing a website having available advertising space;
c) analyzing said buyer profiles based on said available advertising space and based on data in said target user profile;
d) determining a sale price for said available advertising space on said website based on said target user profile and said potential buyers;
e) compiling a list of said potential buyers based on analyses in steps a) and b);
f) offering said available advertising space at a specific price to each potential buyer in said list, an offer being made to each potential buyer in turn;
g) continuously executing step f) until said list is exhausted or until one of said potential buyers has accepted said offer.

16. Computer readable media having encoded thereon computer readable and computer executable code that, when executed, implements a method for conducting a sale for advertising space, the method comprising:
a) analyzing previous sales and attempted sales to derive buyer data for a plurality of buyers, said buyer data being based on results of said previous sales;
b) receiving an advertising opportunity from a specific seller for a webpage being viewed by a specific target user;
c) determining parameters for said advertising opportunity based on a target user profile for said specific target user;
d) assessing said buyers based on said parameters and said buyer data to result in assessment results for each one of said buyers;
e) based at least one on said assessment results, compiling a list of potential buyers, said list of potential buyers being a subset of said plurality of buyers;
f) sending an offer for a specific price for said advertising opportunity to a specific potential buyer in said list;
g) receiving sales results from said specific potential buyer in said list;
h) if said sales result is positive, allowing said potential buyer to use specific advertising with said advertising opportunity;
i) if said sales result is negative, repeating steps f)-i) for each of said potential buyers in said list until a positive sales result is received or until said list is exhausted of potential buyers.
